(19) United States
(12) Patent Application Publication
(10) Pub. No.: US 2008/0053376 A1
(43) Pub. Date: Mar. 6, 2008

(54) Tank display device

(76) Inventor: Jeffrey S. Marks, Newport Coast, CA (US)

Correspondence Address: Jeffrey S. Marks, 9 Chatelaine, Newport Coast, CA, 92657, US

(21) Appl. No.: 11/822,178

(22) Filed: Jul. 3, 2007

Related U.S. Application Data
(60) Provisional application No. 60/842,027, filed on Sep. 5, 2006.
(60) Provisional application No. 60/845,750, filed on Sep. 20, 2006.

(51) Int. Cl. G09F 19/12; A01K 63/00; A47F 11/06

(52) U.S. Cl. 119/248; 40/427

(57) ABSTRACT

An aquarium or tank that includes one or a plurality of indentations or holes which are sufficiently large to fit one or a plurality of separate and independent components or cartridges which introduce a new and separate visual element or environment into the aquarium or tank. Adjacent to the wall of the tank on which the indentations are located is a housing which encases and hides the base (or some other portion) of the separate cartridge, and which is accessible to the user, such that they can remove, replace, repair or modify the cartridge.

### PRIORITY CLAIM

This application claims the benefit of U.S. Provisional Patent Application Nos. 60/842,027, filed Sep. 5, 2006, and 60/845,750, filed Sep. 20, 2006, the disclosures of which are hereby incorporated by reference.

### BACKGROUND OF THE INVENTION

1. Technical Field

The present invention relates to the field of aquariums or tanks which incorporate independent components or cartridges which introduce a new and separate visual element to the aquarium or tank.

2. Description of Related Art

Aquariums are popular all over the world. Millions of Americans keep fish as pets in aquariums. Of concern to many aquarium owners is the appearance of the aquarium itself, which complements and adds to the visual display offered by the fish. Several aquarium accessories with mirrors are available for enhancing the appearance of an aquarium. U.S. Pat. No. 3,706,299 issued to Hendges appears to show an aquarium having mirrors and a concealed light positioned at the top, which gives the appearance of a larger number of fish. Additionally, U.S. Pat. No. 3,119,371 issued to Zuckerman appears to show a combination aquarium and mirror, wherein the mirror has a printed image. Similarly, U.S. Pat. No. 3,808,024 to Glidden appears to show an aquarium having a plurality of mirrors for providing an illusion to the observer of a larger number of fish. Also, U.S. Pat. No. 6,742,477 issued to Marraudino, discloses a decorative background assembly for an aquarium, having a plurality of interchangeable illustrated display panels, for enhancing the appearance of the aquarium. None of these devices, however, appears to allow a separate and independent environment to be incorporated into the aquarium.

In addition, containers or tanks of water or other liquid (that do not contain fish) are often used as visual displays. A number of prior patents disclose display devices that include transparent containers with fluid therein. For example, U.S. Pat. No. 5,106,660 issued to Vorel, discloses a decorative wall panel comprising two parallel, vertically disposed spaced panes of glass that are sealed along the bottom and side edges. The panels form a space that is filled with fluid. At the bottom of the space is a porous tube through which air is dispersed to generate a curtain of bubbles that rises through the fluid. The curtain of bubbles is illuminated by lights disposed at the edges of the panel. U.S. Pat. No. 6,187,394 issued to Johnson et al., discloses a bubbling fluid display device that includes a variable-pressure air source which injects air into a fluid within a panel at variable flow rates into a number of individual chambers to create a unique bubbling pattern for each chamber which includes large bubbles which move upwards within the fluid in the display, and smaller bubbles which move downwards within the fluid in the display. U.S. Pat. No. 5,363,577 issued to Fuller et. al., discloses a fluid display device comprising a plurality of adjacent, parallel tubes filled with a fluid and connected to an air source that injects bubbles into the tubes. The display further comprises a computer that controls the introduction of bubbles to each tube such that the combination of bubbles form a legible design, such as a picture or a word.

U.S. Pat. No. 5,683,174 issued to Lena, Jr., discloses an artistic display that directs light through a panel containing at least two fluids with different colors of specific gravities to project a constantly changing wave pattern onto a display surface. The wave pattern results from the slow oscillation of the panel containing the fluids.

U.S. Pat. No. 5,636,669 issued to Price, discloses a system whereby lightweight powdered or colored substances are introduced into hollow transparent panels to selectively change the color of the panels.

None of these previously disclosed inventions discloses a means for incorporating such displays as a separate and independent environment within an aquarium or tank.

### BRIEF SUMMARY OF THE INVENTION

The present invention relates to an enclosed aquarium or tank which may be built into a wall or ceiling as a panel or otherwise, or into a unit of furniture, or which may be free standing, that includes one or a plurality of indentations or holes on the bottom, the top, the sides and/or on the back of the tank, which are sufficiently large to fit one or a plurality of separate and independent components or cartridges which introduce a new and separate visual element or environment into the aquarium or tank. Adjacent to the location on the aquarium or tank at which the indentations or holes are located (i.e., the base, back, side or top of the tank) is a housing which encases the separate component and which is accessible to the user, so the user can remove, replace, repair or modify the component part. Reference to a wall of the aquarium or tank herein may include the floor, ceiling or any wall of the tank.

### BRIEF DESCRIPTION OF THE SEVERAL VIEWS OF THE DRAWINGS

The subject invention will hereinafter be described in conjunction with the appended drawing figures, wherein like numerals denote like elements, and:

FIG. 1 is one depiction of an aquarium and cabinet as described above;

FIG. 2 is one depiction of a tank and cabinet as described above; and

FIG. 3 is one depiction of a tank and cabinet as described above.

### DETAILED DESCRIPTION OF PREFERRED EMBODIMENTS

### Interpretation Considerations

When reading this section I have described several preferred embodiments of the invention, however, one should keep in mind several points. First, the following preferred embodiments are what the inventor believes to be the best mode for practicing the invention at the time this patent was filed. Thus, since one of ordinary skill in the art may recognize from the following preferred embodiment that substantially equivalent structures or substantially equivalent acts may be used to achieve the same results in exactly the same way, or to achieve the same results in a not dissimilar way, the following preferred embodiments should not be interpreted as limiting the invention to those embodiments. Also, this invention should not be deemed to be limited to fish tanks. It can also be used in connection with tanks that contain other animals, or no animals.

Likewise, individual aspects of the invention are provided as examples, and, accordingly, one of ordinary skill in the art may recognize from a following preferred structure (or a following preferred act) that a substantially equivalent structure or substantially equivalent act may be used to either achieve the same results in substantially the same way, or to achieve the same results in a not dissimilar way. Furthermore, it is recognized that as technology develops, a number of additional alternatives to achieve an aspect of the invention may arise. Such advances are hereby incorporated herein, and should be recognized as being functionally equivalent or structurally equivalent to the aspect shown or described herein.

Second, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Third, unless explicitly stated otherwise, conjunctive words (such as “or”, “and”, “including”, or “comprising” for example) should be interpreted in the inclusive, not the exclusive, sense.

In addition, one of ordinary skill in the art can appreciate that the indentations or holes can be located on any surface of the tank, including, the walls, the floor or at the top of the tank. One of ordinary skill in the art can also appreciate that the component cartridge may encase any number of possible liquids, gasses, substances or objects. For example, cartridges could encase sand, a simple light, gas, a lava lamp type fluid convection system, a mirror, a plant, a pet or even a different species of fish that, for one reason or another, cannot be kept in the same tank as the other fish. One of ordinary skill in the art can further appreciate that the component cartridges can be of any conceivable shape and size, and that correspondingly, the indentations or holes in the tank walls can be of any conceivable shape or size, so as to fit the component cartridges. One of ordinary skill in the art can also appreciate that such indentations or holes, and component cartridges, could be incorporated into a tank of any conceivable shape or size. As an example, an indentation large enough to fit a person could be incorporated into a very large tank.

### DISCUSSION OF FIGURES

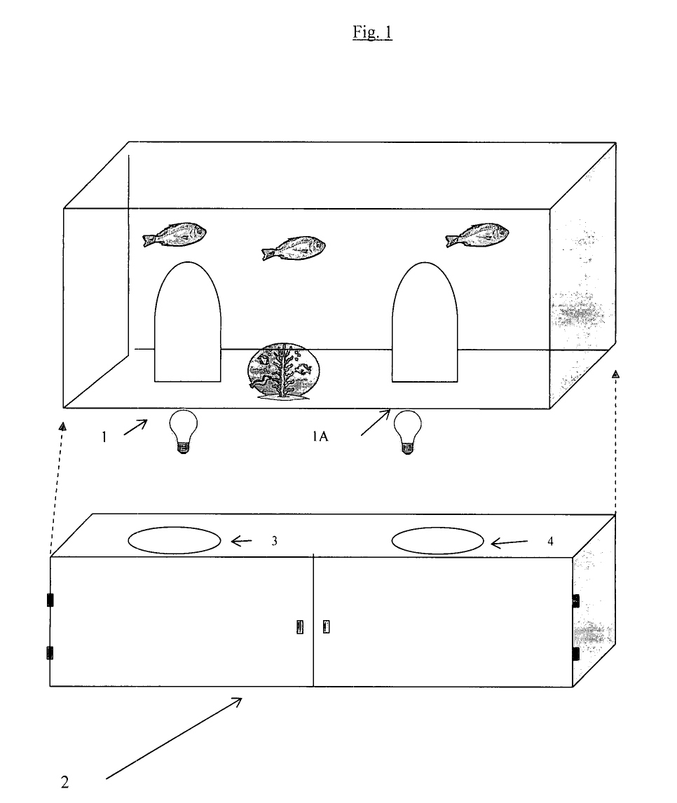

FIG. 1. is a depiction of a glass fish tank which includes two indentations 1 & 1A at the bottom of the tank into which the separate component parts may fit. FIG. 1 also depicts a cabinet 2 on which the tank sits and which houses the cartridges, and depicts holes 3 & 4 which correspond to the indentations 1 & 1A through which the cartridges may protrude through the cabinet casing and up into the indentations in the tank.

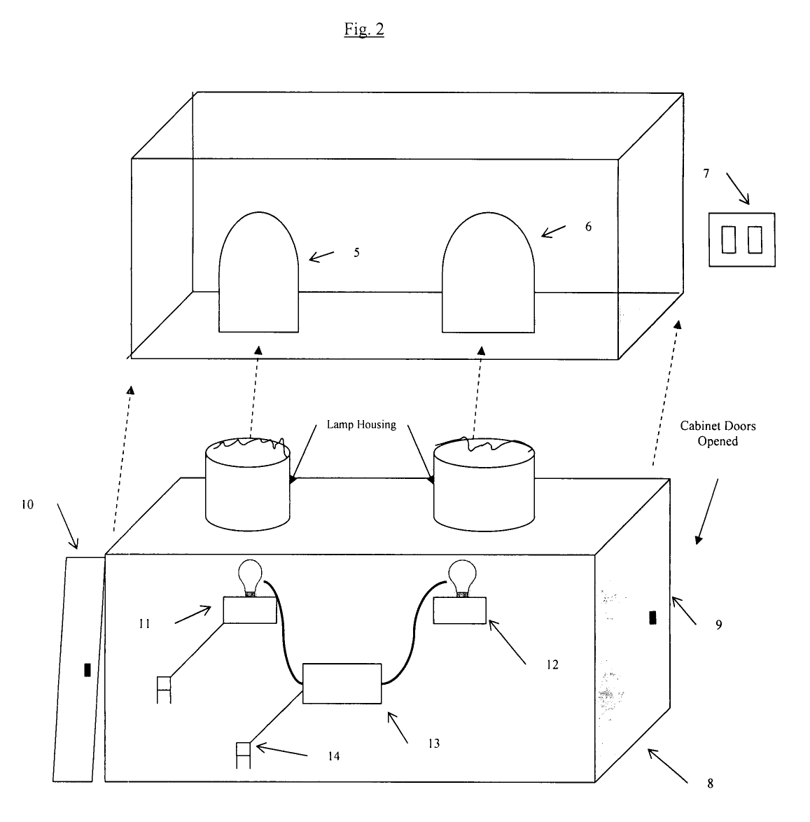

FIG. 2. is another depiction of a fish tank which includes two indentations 5 & 6, which are of varying sizes. FIG. 2 also depicts an exterior power switch 7 that turns various features of the tank on or off. It also depicts the cabinet 8 on which the tank sits depicting the doors of such cabinet 9 & 10 open. It depicts lava lamp-type convection devices 11 & 12 within the cabinet 8, as well as a ventilation/temperature control system 13 and an external plug 14.

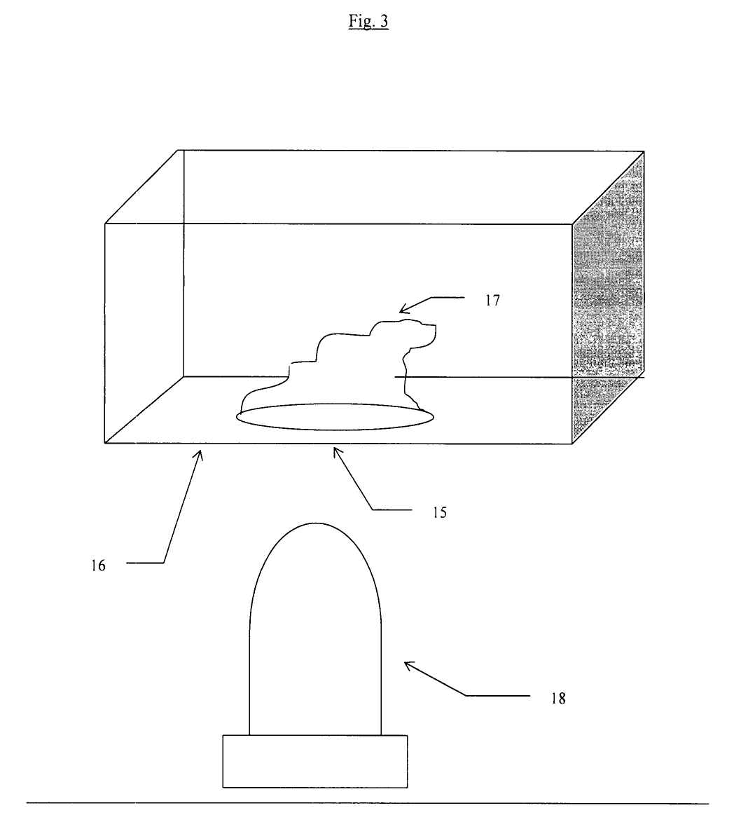

FIG. 3. is a depiction a fish tank in which a hole 15 is cut into the bottom of the tank 16. Affixed to the hole is a flexible or elastic, and translucent, water proof material (such as plastic) 17 into which a component cartridge 18 part may be inserted and which shall tightly cover such component like a tight glove.

I claim:

1. An enclosed glass tank which may be built into a wall or ceiling as a panel or otherwise, or into a unit of furniture, or which may be free standing, comprising: a glass tank with one or a plurality of indentations on one or more walls of the tank, which are sufficiently large to house a separate component part or cartridge, which can be incorporated into the tank.

2. The tank as in claim 1, where such indentations are formed or molded directly on the tank wall such that the wall and indentations are one continuous piece of material.

3. The tank as in claim 1, where such indentations are holes of certain sizes cut out of such wall, and affixed to such holes is a flexible or elastic, and translucent, water proof material (such as plastic or rubber) into which the component part may be inserted and which shall tightly cover such component part like a tight glove.

4. The tank as in claim 3 which includes a small compartment incorporated into the wall of the tank into which the material can fit when a cartridge is not inserted therein.

5. The tank as in each of claims 1-4, in which the separate component part is filled with colored liquid, sand, a light bulb, or any other substance or device, and which can be inserted into the indentation.

6. The tank as in each of claims 1-5, that is comprised of or incorporates a decorative display device such as those described under Description Related Art, or includes a device similar to such display devices.

7. The tank in each of claims 1-6, wherein said separate component is a cartridge that can be fit into the indentation or hole, whether through a screw-like mechanism, and snap and lock type mechanism or otherwise.

8. The tank as in each of claims 1-7, wherein such tank is Plexiglas, fiberglass, or made of some other opaque material other than glass, or where such tank is a combination of glass, and one or more other opaque or non-opaque materials.

9. The tank as in each of claims 1-8, in which the tank wall containing the indentation or hole is adjacent to a special cabinet or other structure, which supports, encases and hides the base or some other portion of the separate component cartridge, and which is accessible to the user, permitting the user to remove, replace, repair or modify said component cartridge.

10. The tank in each of claims 1-9, which incorporates a device that provides ventilation, cooling, heating or applies a chemical, between the cartridge and the tank wall, or to the tank wall or the component cartridge, so as to prevent fogging, condensation or other effects that may cause a blurring, discoloration or otherwise, of the inside or outside of the tank wall or component cartridge.

11. The tank in each of claims 1-10, wherein the component cartridges inserted in the indentations or holes are connected to a power source which can be turned on or off manually through a switch located in an accessible location.

12. The tank in each of claims 1-11, wherein the cartridge component is made of a material that keeps all heat and cold generated by such cartridge from heating or cooling the water in the tank.

13. The tank in each of claims 1-12, which incorporates a temperature monitoring device which automatically adjusts the temperature of the water in the tank to compensate for any heat that is generated by the cartridge component.

14. The tank as in each of claims 1-13, where the indentations in the tanks are holes of certain sizes cut out of such wall, to which can be attached the separate component part which may be affixed and tightened via a screw type mechanism, or some other method of affixing and attaching an independent component to a unit in such a manner that it would be without leakage.
